(19) United States
(12) Patent Application Publication
(10) Pub. No.: US 2025/0224857 A1
(43) Pub. Date: Jul. 10, 2025

(54) INFORMATION PROCESSING APPARATUS, AND CONTROL METHOD

(71) Applicant: CANON KABUSHIKI KAISHA, Tokyo (JP)

(72) Inventor: YUKI KATSUDA, Kanagawa (JP)

(21) Appl. No.: 19/008,150

(22) Filed: Jan. 2, 2025

(30) Foreign Application Priority Data
Jan. 5, 2024 (JP) 2024-000698

(51) Int. Cl. G06F 3/04842; G06F 3/0488; H04N 1/00

(52) U.S. Cl. CPC G06F 3/04842; H04N 1/00411; H04N 1/00464; H04N 1/00501; G06F 3/0488; H04N 2201/0094

(57) ABSTRACT

In order to offer better user experience, provided is an information processing apparatus including at least one memory and at least one processor which function as a display control unit that performs control to display a screen including a first object and a second object different from the first object, a first obtainment unit that obtains a pressed coordinate point which is a coordinate point on the screen where an input operation on the screen by a user is performed, and a determination unit that makes a determination as to an object selected by the input operation by comparing a first priority level set for a type of the first object disposed within a predetermined range from the pressed coordinate point and a second priority level set for a type of the second object disposed within the predetermined range.

### BACKGROUND

### Field of the Disclosure

The present disclosure relates to an information processing apparatus, and a control method.

### Description of the Related Art

An information processing apparatus such as a personal computer (PC) or a smartphone can obtain display information for a web application (hereinafter referred to as a web app) by connecting to a web server on a network. Then, the information processing apparatus can display the obtained display information using a display function of a web browser. Also, some image formation apparatuses including a multifunction peripheral (MFP) with a copy function and a transmission function include a web browser for displaying a web app. A component (hereinafter referred to as a web content) on the screen of a web app displayed on a touch panel of such information processing apparatuses can be selected by a user operation. In this operation, there is a possibility that the user may select an unintended web content by mistake.

As a method for avoiding erroneous selection of a web content, Japanese Patent Laid-Open No. 2013-222290 discloses a method which changes a selection target to a smaller web content located within a predetermined distance from the coordinate point of the touched position.

### SUMMARY

Embodiments of the present disclosure provide a method for properly reducing occurrence of erroneous selection of a web content.

An information processing apparatus according to embodiments of the present disclosure is an information processing apparatus comprising: at least one memory and at least one processor which function as a display control unit that performs control to display a screen including a first object and a second object different from the first object, a first obtainment unit that obtains a pressed coordinate point which is a coordinate point on the screen where an input operation on the screen by a user is performed, and a determination unit that makes a determination as to an object selected by the input operation by comparing a first priority level set for a type of the first object disposed within a predetermined range from the pressed coordinate point and a second priority level set for a type of the second object disposed within the predetermined range.

Further features of the present disclosure will become apparent from the following description of exemplary embodiments with reference to the attached drawings.

### BRIEF DESCRIPTION OF THE DRAWINGS

FIG. 1 is a diagram showing an example overall configuration of an information processing system.

FIG. 2 is a block diagram showing an example hardware configuration of an image formation apparatus.

FIG. 3 is a block diagram showing an example hardware configuration of a web server.

FIG. 4 is a diagram showing an example configuration of software modules in the image formation apparatus.

FIG. 5 is a diagram showing an example of a web content information table.

FIG. 6 is a diagram showing an example of a means for obtaining an HTML element.

FIG. 7 is a diagram showing an example of a priority order table.

FIG. 8 is a flowchart showing an example of coordinate replacement processing.

FIG. 9A is a diagram showing an example of a display screen on an operation unit.

FIG. 9B is a diagram showing an example where a defined range is shown on the displace screen in FIG. 9A.

FIG. 9C is a diagram showing an example of a close-up of the area of the defined range in FIG. 9B.

FIG. 10A is a diagram showing an example where web contents are disposed within the defined range.

FIG. 10B is a diagram showing an example where web contents are disposed within the defined range.

FIG. 11 is a flowchart showing an example of coordinate replacement processing.

FIG. 12 is a diagram showing an example of a web content information table.

FIG. 13 is a diagram showing an example of a means for obtaining the size of a web content.

FIG. 14 is a diagram showing an example configuration of software modules in the image formation apparatus.

FIG. 15A is a diagram showing an example of a display screen on the operation unit.

FIG. 15B is a diagram showing a screen for setting a defined range.

FIG. 15C is a diagram showing a web app selection screen for setting the priority order of HTML elements for each web app.

FIG. 15D is a diagram showing a screen for setting the priority order of HTML elements of a web app.

### DESCRIPTION OF THE EMBODIMENTS

Preferred embodiments of the present disclosure are described in detail below with reference to the drawings attached hereto. Note that the embodiments below do not limit the matters of the present disclosure and that not all the combinations of features described in the embodiments below are necessarily essential as solutions provided by the present disclosure. Note that the same constituents are described using the same reference number.

A web browser that an information processing apparatus has can display a web app. In selecting a small web content on the screen of the web app, a user can visually identify the selection target in a case of using a mouse cursor, but may fail to visually identify the selection target in a case of using a finger because the finger covers the selection target. By failing to visually identify the selection target, the user may end up selecting an unintended web content, which leads to additional work such as re-pressing on the web content or re-transitioning to the web app. Note that, even in a case where the selection target can be visually identified, other factors may cause selection of a web content unintended by a user. Also, even in a case where a web content to be selected is adequately large, erroneous selection may occur due to an overlap with another web content. What is desired is a method for avoiding such erroneous selection properly in a situation where a user selects a web content displayed on a web browser.

In the embodiments below, an image formation apparatus (or specifically a MFP) is described as an example of an information processing apparatus having a typical web browser. However, the information processing apparatus is not limited to this. The information processing apparatus may be, for example, a desktop PC, a laptop PC, a tablet terminal, a smartphone, or the like.

### First Embodiment

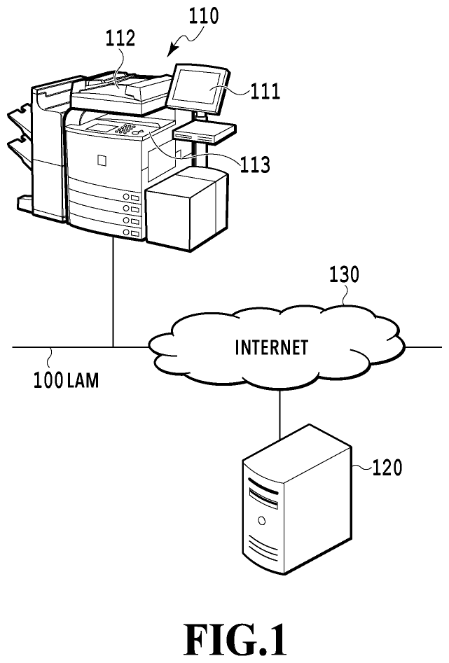

FIG. 1 is a diagram showing an example overall configuration of an information processing system according to an embodiment of the present disclosure. The information processing system includes an MFP 110 and a web application server 120. In the present embodiment, the MFP 110 is described as an example of an image formation apparatus. In the information processing system, the MFP 110 is connected to an Internet 130 via a LAN 100. Further, the web application server 120 is connected to the Internet 130.

The MFP 110 includes an operation unit 111, a scanner unit 112, and a printer unit 113. The MFP 110 according to the embodiment functions as a client terminal that displays a screen for operating a web app using a web browser incorporated therein and is operated by a user. Upon receiving a predetermined instruction via the web app, the MFP 110 can transmit image data obtained by reading an original using the scanner unit 112 to the web application server 120. Also, the MFP 110 can print image data obtained from the web application server 120 using the printer unit 113.

The web application server 120 is a server that executes a web app. Note, however, that the configuration of the information processing system shown in FIG. 1 is merely an example, and the number of these devices and the like are not limited to this example.

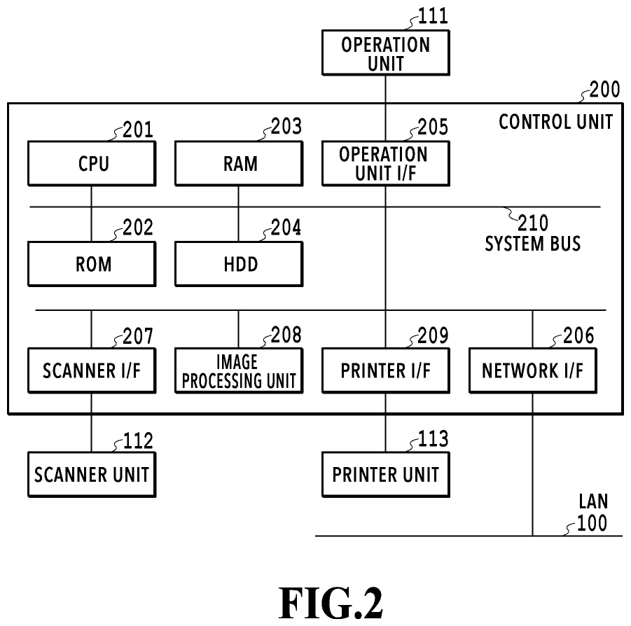

FIG. 2 is a block diagram showing an example hardware configuration of the MFP 110 according to the present embodiment. The MFP 110 includes a control unit 200 that controls the operation unit 111, the scanner unit 112, and the printer unit 113. The control unit 200 includes a CPU 201, a ROM 202, a RAM 203, an HDD 204, an operation unit interface (hereinafter referred to as I/F) 205, a network I/F 206, a scanner I/F 207, an image processing unit 208, and a printer I/F 209.

The operation unit 111 has a display with a touch panel function and also has various hard keys and the like. The operation unit 111 receives a user operation performed on the display, a hard key, or the like and inputs information related to the received operation to the control unit 200 via the operation unit I/F 205 to be described later. As controlled by the control unit 200, the operation unit 111 performs display control for displaying various kinds of images via the operation unit I/F 205.

The scanner unit 112 reads an image on an original, creates data on the image thus read, and supplies the created image data to the control unit 200 via the scanner I/F 207 to be described later. The printer unit 113 forms an image on a sheet based on print-related information including the image data, which is received from the control unit 200 via the printer I/F 209 to be described later.

The control unit 200 is electrically connected to the operation unit 111, the scanner unit 112, and the printer unit 113 and is also connected to the LAN 100 via the network I/F 206 to be described later. The MFP 110 can thus perform communications according to communication protocols such as TCP/IP via the LAN 100.

In the control unit 200, the CPU 201, the ROM 202, the RAM 203, the HDD 204, the operation unit I/F 205, the network I/F 206, the scanner I/F 207, the image processing unit 208, and the printer I/F 209 are connected to one another via a system bus 210.

The CPU 201 executes a boot program in the ROM 202, loads an OS and a control program stored in the HDD 204 into the RAM 203, and performs overall control of the MFP 110 based on the loaded program. This control includes execution of a program for implementing the flowchart to be described later.

The ROM 202 stores the boot program, various kinds of data, and the like for the MFP 110. The RAM 203 provides work memory for the CPU 201 to run and also provides image memory for temporarily storing image data. The HDD 204 stores the OS, various programs, image data, and a priority order table to be described later, and the like.

The operation unit I/F 205 is an I/F for connecting the operation unit 111 and the control unit 200. The network I/F 206 is an I/F for connecting the LAN 100 and the control unit 200 and is used to input and output information via a network. The scanner I/F 207 is an I/F for connecting the scanner unit 112 and the control unit 200.

The image processing unit 208 performs image processing, such as rotation, color conversion, image compression, and image decompression, on image data created by the scanner unit 112 and image data to be outputted to the printer unit 113. The printer I/F 209 is an I/F for connecting the printer unit 113 and the control unit 200. Via the printer I/F 209, the CPU 201 controls printing performed by the printer unit 113 according to attribute data attached to the image data processed by the image processing unit 208.

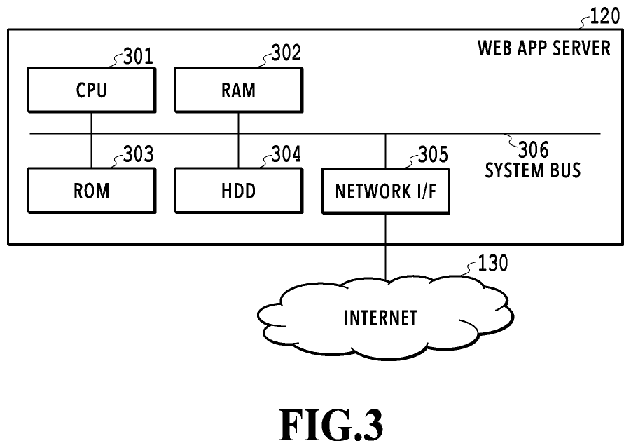

FIG. 3 is a block diagram showing an example hardware configuration of the web application server 120 according to the embodiment. The web application server 120 includes a CPU 301, a RAM 302, a ROM 303, an HDD 304, and a network I/F 305. In the web application server 120, the CPU 301, the RAM 302, the ROM 303, the HDD 304, and the network I/F 305 via a system bus 306.

The CPU 301 executes an OS, control programs, and the like stored in the HDD 304 into the RAM 302 and executes the loaded program, thereby implementing the functions of the web application server 120. Also, the CPU 301 communicates with other apparatuses on the network connected via the network I/F 305.

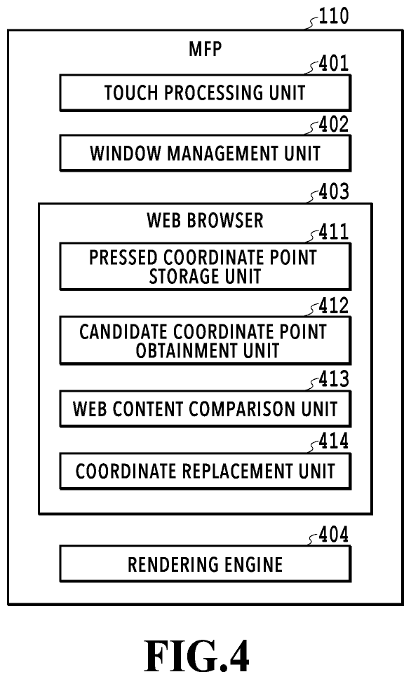

FIG. 4 is a diagram showing an example configuration of software modules in the MFP 110 according to the present embodiment. The MFP 110 includes a touch processing unit 401, a window management unit 402, a web browser 403, and a rendering engine 404. Also, the web browser 403 includes a pressed coordinate point storage unit 411, a candidate coordinate point obtainment unit 412, a web content comparison unit 413, and a coordinate replacement unit 414. These software modules are stored in the HDD 204 of the MFP 110 and, at the time of execution, loaded into the RAM 203 and executed by the CPU 201.

The touch processing unit 401 detects an input operation such as a press on the operation unit 111 and converts analog positional information on the press into digital coordinate information. Although a press operation by a user is described as an example of the input operation performed on the operation unit in the present embodiment, it is to be noted that the present disclosure is not limited to this. For example, the input operation performed on the operation unit may be an instruction operation performed using a mouse. The touch processing unit 401 passes the converted digital coordinate information to the window management unit 402. Based on the digital coordinate information received from the touch processing unit 401 and layer information on a plurality of apps (including the browser) displayed on the operation unit, the window management unit 402 determines which app has been pressed. In a case where the uppermost app on a coordinate point indicated by the coordinate information is the browser, the window management unit 402 determines that the input operation is a press operation on the browser and passes the coordinate information to the web browser 403.

The web browser 403 displays a web app executed by the web application server 120. The web browser 403 has, in addition to a typical function of sending a request to the web application server 120 and displaying a web app on the operation unit 111, the pressed coordinate point storage unit 411, the candidate coordinate point obtainment unit 412, the web content comparison unit 413, and the coordinate replacement unit 414.

The pressed coordinate point storage unit 411 stores coordinate information (hereinafter referred to as a pressed coordinate point) obtained from the window management unit 402 and an HTML element located at the coordinate position, into the HDD 204 as a web content information table. Hereinbelow, storing coordinate information along with information associated with the coordinate information into the HDD 204 in a table format is referred to as storing in a table. Note that in the present embodiment, the format for storing coordinate information and information associated with the coordinate information is not limited to a table. Specifically, any format can be used as long as it is a method with which coordinate information and information associated with the coordinate information can be managed. An HTML element is publicly known information indicating the nature of a web content, which is written at the time of creation of a web app using hypertext markup language (HTML) or the like. In other words, an HTML element indicates the type of a web content. Although the present embodiment describes an example where a web content is an image constituting a web app, a web content may be an object such as an input form, a button, or a link.

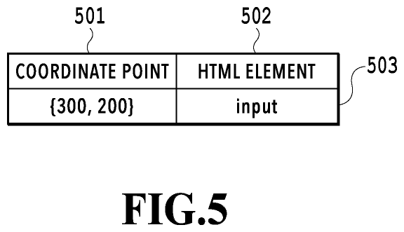

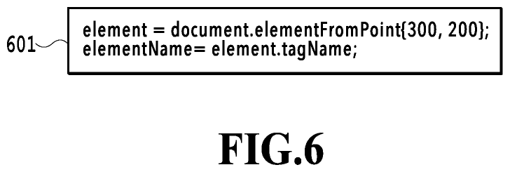

FIG. 5 shows an example of the web content information table. The web content information table is formed by a coordinate point 501, an HTML element 502, and a row 503. The coordinate point 501 indicates a stored coordinate point on a web browser display region. The HTML element 502 indicates the HTML element of a web content disposed at a position overlapping with the coordinate point stored in the coordinate point 501 (hereinafter referred to as an HTML element corresponding to a coordinate point). In the row 503, a pressed coordinate point and an HTML element corresponding to the pressed coordinate point are stored before execution of coordinate replacement processing to be described later. Specifically, as shown in FIG. 5, a coordinate point {300, 200} and an INPUT element as an HTML element corresponding to the coordinate point {300, 200} are stored in the row 503. FIG. 6 shows an example of a means for obtaining an HTML element corresponding to a pressed coordinate point. An HTML element can be obtained from a description 601 as shown in FIG. 6 using JavaScript or the like. By using the means shown in FIG. 6, the pressed coordinate point storage unit 411 can obtain a character string representing the HTML element corresponding to the coordinate point {300, 200} specified. Note that in the present embodiment, the HTML element of a web content disposed at a position overlapping with a pressed coordinate point or with a candidate coordinate point to be described later is referred to as an HTML element corresponding to the coordinate point. Note that an HTML element corresponding to a certain coordinate point is the HTML element of the frontmost one of the web contents disposed at a position overlapping with the certain coordinate point.

Referring back to FIG. 4, the candidate coordinate point obtainment unit 412 obtains coordinate points located within a predetermined range from a pressed coordinate point (hereinafter referred to as candidate coordinate points) and HTML elements corresponding to the candidate coordinate points. The region of the predetermined range from a pressed coordinate point is hereinafter referred to as a defined range. Providing the defined range can complement a displacement of a pressed position due to a user not being able to visually identify the selection target, so that the selection operation can be performed as intended by the user.

The web content comparison unit 413 compares the priority level of the HTML element corresponding to the coordinate point stored in the web content information table and the priority levels of the HTML elements corresponding to the candidate coordinate points. The web content comparison unit 413 determines a coordinate point with a high priority level based on the priority levels of the HTML elements defined in a priority order table to be described later.

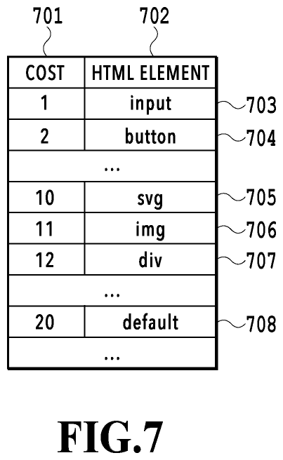

FIG. 7 shows an example of the priority order table. The priority order table is formed by a combination of a cost 701 and an HTML element 702. The cost 701 indicates the priority level of an HTML element set for the cost. The cost 701 is used for comparison of the priority level of a coordinate point associated with the HTML element, and the smaller the numerical value of the cost 701, the higher the priority level. The HTML element 702 has arbitrarily set HTML elements. As shown in FIG. 7, rows 703 to 708 are set as HTML elements. Predetermined HTML elements are set for the costs. For instance, looking at the rows 703 and 704, the cost corresponding to the INPUT element is smaller than the cost corresponding to the BUTTON element. Thus, the web content comparison unit 413 determines that the INPUT element has a higher priority level. Also, providing the priority order table with a unique DEFAULT element like in a row 708 enables all the HTML elements not set in the HTML element 702 to be handled as having the priority level of the DEFAULT element. The priority order table is stored in memory such as the HDD 204.

Referring back to FIG. 4, the coordinate replacement unit 414 replaces information stored in the web content information table with information on a coordinate point and an HTML element associated with this coordinate point determined by the web content comparison unit 413 as having a high priority level. As a result, the information on the coordinate point determined as having a high priority level is stored in the web content information table. In a case considered here, a pressed coordinate point and an IMG element as an HTML element corresponding to the pressed coordinate point are stored in the web content information table, and the candidate coordinate point obtainment unit 412 obtains a candidate coordinate point and an SVG element as an HTML element corresponding to the candidate coordinate point. In this case, the web content comparison unit 413 determines based on the priority order table in FIG. 7 that the SVG element has a smaller cost than the IMG element, i.e., that the candidate coordinate point has a higher level of priority. Then, based on the determination by the web content comparison unit 413, the coordinate replacement unit 414 stores, in the web content information table, the candidate coordinate point and the HTML element corresponding to the candidate coordinate point. In other words, the coordinate replacement unit 414 can determine that a web content disposed at a position overlapping with the coordinate point determined as having a high priority level is the web content selected by the user. The web browser 403 executing such processing enables selection processing to be performed as intended by a user. This means that occurrence of erroneous selection by a user can be reduced. Note that in the present embodiment, a web content corresponding to obtained information related to a pressed coordinate point or a candidate coordinate point (information such as an HTML element) is referred to as a web content corresponding to the coordinate point.

The rendering engine 404 generates image data to be displayed on the operation unit 111 based on resources of a web page returned as a response to a request transmitted by the web browser 403. The rendering engine 404 receives coordinate information from the web browser 403 and executes processing according to the coordinate information finally stored in the web content information table by the coordinate replacement unit 414

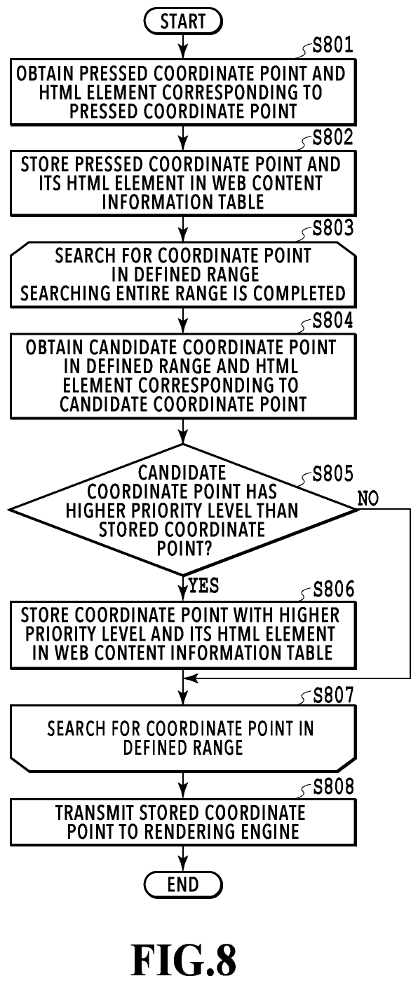

FIG. 8 is a flowchart showing an example of coordinate replacement processing executed by the MFP 110 in the present embodiment. The processing shown in FIG. 8 is implemented by the CPU 201 of the MFP 110 by reading a program stored in the ROM 202 into the RAM 203 and executing the program. Note that some or all of the functions in the processing shown in FIG. 8 may be implemented by hardware such as an ASIC or an electric circuit. The letter “S” in the description of each processing means that it is a step in the flowchart (the same applies to the rest of the flowcharts herein).

In S801, using the pressed coordinate point storage unit 411, the CPU 201 obtains a pressed coordinate point passed from the window management unit 402 to the web browser 403. Then, based on coordinate information on the pressed coordinate point obtained, the CPU 201 obtains an HTML element corresponding to the pressed coordinate point. After that, the CPU 201 proceeds to processing in S802.

In S802, using the pressed coordinate point storage unit 411, the CPU 201 stores information on the pressed coordinate point and the HTML element corresponding to the pressed coordinate point into the web content information table. After that, the CPU 201 proceeds to processing in S803.

In S803, using the candidate coordinate point obtainment unit 412, the CPU 201 starts iteration processing on candidate coordinate points located within a defined range from the pressed coordinate point. In the iteration processing, the CPU 201 executes the processing from S804 to S806 to be described later on each of the candidate coordinate points within the defined range. The iteration processing is iterated until the processing in S804 to S806 is completed for all the candidate coordinate points.

In S804, using the candidate coordinate point obtainment unit 412, the CPU 201 obtains coordinate information on the candidate coordinate point currently targeted by the current iteration processing and an HTML element corresponding to this candidate coordinate point. After that, the CPU 201 proceeds to processing in S805.

In S805, using the web content comparison unit 413, the CPU 201 compares, based on a priority order table like the one shown in FIG. 7, the HTML element stored in the web content information table and the HTML element corresponding to the candidate coordinate point obtained in S804. More specifically, the CPU 201 compares the priority levels of the respective coordinate points by comparing the priority levels of the HTML elements associated with the respective coordinate points based on the priority order table. As a result of the comparison, the CPU 201 proceeds to processing in S806 if the priority level of the candidate coordinate point is determined to be higher than that of the stored coordinate point (YES). Meanwhile, the CPU 201 proceeds to S807 if the priority level of the stored coordinate point is determined to be higher than or the same as that of the candidate coordinate point (NO).

In S806, using the coordinate replacement unit 414, the CPU 201 replaces the combination of the coordinate point stored in the web content information table and the HTML element corresponding to the coordinate point with the combination of the candidate coordinate point determined to have a higher priority level and the HTML element corresponding to this candidate coordinate point.

In S807, the CPU 201 proceeds to processing in S804 if the iteration procession has not been completed for all the candidate coordinate points within the defined range. Meanwhile, the CPU 201 proceeds to processing in S808 if the iteration procession has been completed for all the candidate coordinate points within the defined range.

In S808, using the web browser 403, the CPU 201 passes the coordinate information stored in the web content information table to the rendering engine 404 and ends the processing shown in FIG. 8.

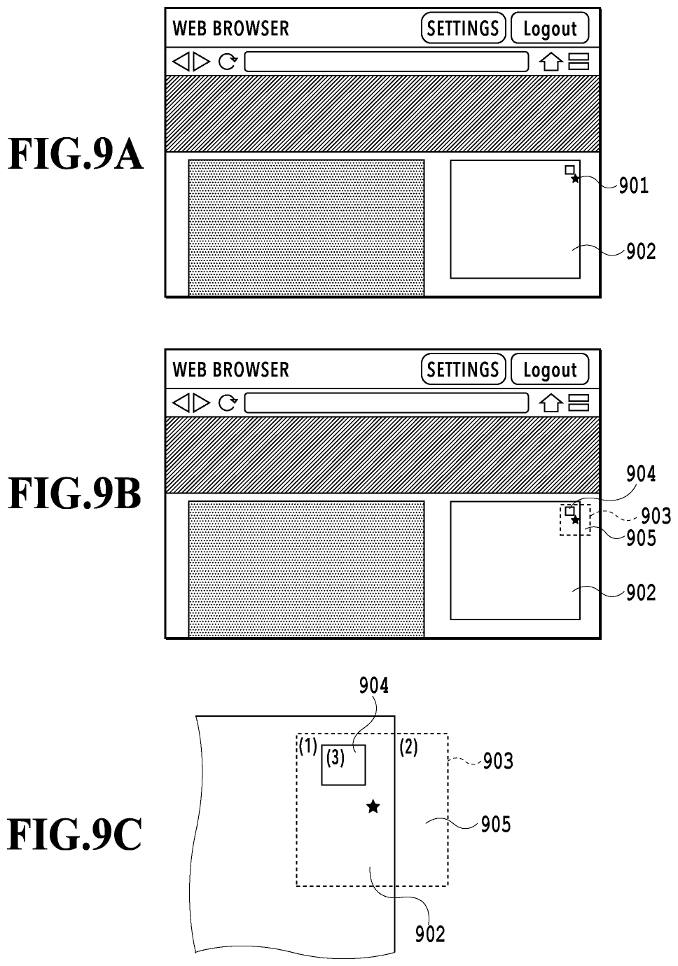

FIGS. 9A to 9C are diagrams showing an example of display screens displayed by the operation unit 111 according to the present embodiment. The processing shown in FIG. 8 is described in detail with reference to a specific case shown in FIGS. 9A to 9C.

FIG. 9A is a diagram showing an example of a display screen of the web browser 403 displayed on the operation unit 111. A pressed coordinate point 901 indicates the position of the pressed coordinate point. A web content 902 is an image in a display advertisement constituting a web app and measuring 300 px×300 px in size. The HTML element of the web content 902 is an IMG element. In S801, the pressed coordinate point storage unit 411 obtains the pressed coordinate point 901 and then obtains information indicating that an IMG element is the HTML element of the web content 902 located on the pressed coordinate point 901. After obtaining the HTML element corresponding to the pressed coordinate point 901 in S801, in S802, the pressed coordinate point storage unit 411 stores the pressed coordinate point 901 and the HTML element obtained in S801 into the web content information table.

FIG. 9B is a diagram showing a defined range on FIG. 9A on which to execute the iteration processing. A defined range 903 represents a predetermined range on which to execute the iteration processing. For example, the defined range 903 is a rectangular range of 61 px×61 px extending for a distance of 30 px from the pressed coordinate point 901. A web content 904 is a graphic measuring 15 px×15 px in size, disposed on the upper corner of the web content 902, and representing an icon for deleting the display advertisement. The HTML element of the web content 904 is an SVG element. A web content 905 is a group region grouping other web contents. The HTML element of web content 905 is a DIV element.

The iteration processing in S803 is executed on the 61×61 candidate coordinate points on the defined range 903. In S804, in the event where a coordinate point on the web content 902 is the target of the iteration processing, the candidate coordinate point obtainment unit 412 obtains information indicating that an IMG element is the HTML element corresponding to the candidate coordinate point. Similarly, in the event where a coordinate point on the web content 904 is the target of the iteration processing, the candidate coordinate point obtainment unit 412 obtains information indicating an SVG element, and in the event where a coordinate point on the web content 905 is the target of the iteration processing, the candidate coordinate point obtainment unit 412 obtains information indicating a DIV element.

FIG. 9C is a diagram showing a close-up of the area around the defined range 903 in FIG. 9B. The numbers (1) to (3) in FIG. 9C indicate the positions of candidate coordinate points inside the defined range 903. The coordinate point at (1) is hereinafter referred to as a coordinate point (1), and similarly, the coordinate points at (2) and (3) are referred to as coordinate points (2) and (3), respectively (the same applies to the rest of the embodiments). Also, the coordinate points (1), (2), and (3) are targeted by the iteration processing in the order as numbered. In the event where the coordinate point (1) is the target of the iteration processing, the HTML element corresponding to the coordinate point stored in the web content information table is an IMG element, and the HTML element corresponding to the coordinate point (1) which is the candidate coordinate point is an IMG element. Then, in S805, the web content comparison unit 413 refers to a row 706 in the priority order table in FIG. 7 and determines that both coordinate points have the same priority level because their HTML elements (specifically, an IMG element) have the same cost. In this case, the coordinate replacement unit 414 does not perform the replacement processing described earlier.

In the event where the coordinate point (2) is the target of the iteration processing, the HTML element corresponding to the coordinate point stored in the web content information table is an IMG element, and the HTML element corresponding to the coordinate point (2) which is the candidate coordinate point is a DIV element. Then, the web content comparison unit 413 refers to rows 706 and 707 in the priority order table in FIG. 7 and determines that the stored coordinate point has a higher priority level because the IMG element has a higher cost than the DIV element. In this case, the coordinate replacement unit 414 does not perform the replacement processing described earlier.

In the event where the coordinate point (3) is the target of the iteration processing, the HTML element corresponding to the coordinate point stored in the web content information table is an IMG element, and the HTML element corresponding to the coordinate point (3) which is the candidate coordinate point is an SVG element. Then, the web content comparison unit 413 refers to rows 705 and 706 in the priority order table in FIG. 7 and determines that the coordinate point (3) has a higher priority level because the SVG element has a higher cost than the IMG element. In S806, the coordinate replacement unit 414 replaces the combination of the coordinate point stored in the web content information table and the HTML element corresponding to this coordinate point with the combination of the candidate coordinate point determined in S805 and the HTML element corresponding to this candidate coordinate point. After the iteration processing ends, in S808, the combination of the coordinate point and the HTML element corresponding to the coordinate point stored in the web content information table is the coordinate point (3) and the SVG element. Then, the web browser 403 passes this combination to the rendering engine 404.

According to the present embodiment, the priority order table is set in advance based on the components of a web app on which to execute the processing, and the processing shown in FIG. 8 is executed to reduce occurrence of erroneous selection by a user. A case is considered here where, as in FIG. 9A, a user presses and erroneously selects the web content 902, which is a display advertisement, despite the intention to select the web content 904, which is an icon for deleting the display advertisement. Because the size of the web content 904 is small relative to the size of the web content 902, it is highly likely that the operation of pressing the web content 902 is an erroneous operation. Thus, the priority order table is set in advance so that the HTML element of the web content 904 may have a small cost. This enables a candidate coordinate point on the web content 904 to be selected anew as a candidate coordinate point with the highest priority level from the candidate coordinate points in the defined range 903, making it possible to achieve processing where a web content expected by a user is selected.

Also, for example, in addition to the condition for determining erroneous selection based on the size of a web content, a low cost may be set for the HTML element of a web content to be prioritized as a selection target, and a high cost may be set for the HTML element of a web content which may serve as a different factor for erroneous selection. This enables better user experience because a coordinate point is selected based on the priority order reflecting a plurality of selection criteria so that erroneous selection by a user due to a factor other than the size of a web content can be addressed as well.

### Second Embodiment

A case is conceivable where the defined range on which the candidate coordinate point obtainment unit 412 executes the iteration processing includes a plurality of web contents belonging to HTML elements with small costs. The present embodiment describes processing performed in the above case so that a user can get the outcome that they expect from a web content selection operation. Note that the following description focuses on differences from the first embodiment and may omit descriptions of similar configurations.

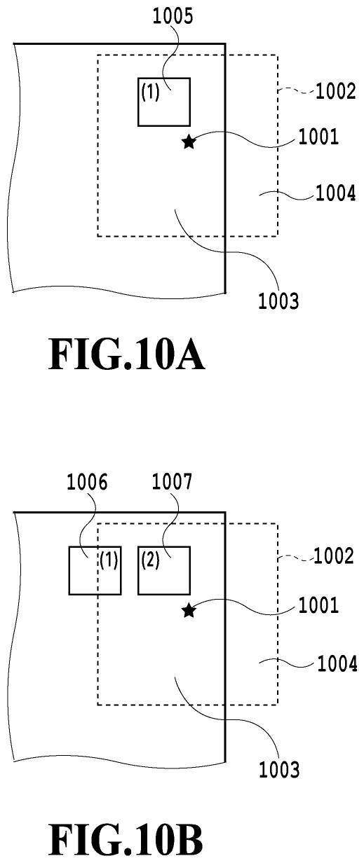

FIGS. 10A and 10B are diagrams showing an example of a display screen displayed on the operation unit 111, showing a close-up of the area of the defined range. FIGS. 10A and 10B show cases where the defined range includes web contents each belonging to an HTML element with a small cost. FIG. 10A is a diagram showing a case where the costs of HTML elements of web contents 1003 and 1005 are lower than the cost of the HTML element of a web content 1004, the web contents 1003 and 1005 being different in size. FIG. 10B is a diagram showing a case where the costs of the HTML elements of web contents 1006 and 1007 are lower than the cost of the HTML element of the web content 1003, the web contents 1006 and 1007 being the same in size.

A pressed coordinate point 1001 in FIGS. 10A and 10B indicates the position of a pressed coordinate point obtained by the web browser 403 and is the same as the pressed coordinate point 901 in FIG. 9A. A defined range 1002 in FIGS. 10A and 10B indicates a predetermined range on which to execute the iteration processing and is the same as the defined range 903 in FIG. 9B. The web content 1003 in FIGS. 10A and 10B is a web content whose HTML element is an IMG element and which measures 300 px×300 px in size. The web content 1004 in FIGS. 10A and 10B is a web content whose HTML element is a DIV element. In this case, because the web content 1003 is on the pressed coordinate point 1001, an IMG element is stored in the web content information table as an HTML element corresponding to the pressed coordinate point 1001.

In FIG. 10A, the web content 1005 is a web content whose HTML element is an IMG element and which measures 15 px×15 px in size. The symbol (1) indicates the position of a candidate coordinate point, and the candidate coordinate point (1) is {705, 200}. In the example in FIG. 10A, a case is considered where the pressed coordinate point 1001 is passed to the web browser 403 as erroneous selection of the web content 1005, and the processing in FIG. 8 is executed based on the priority order table in FIG. 7.

In the above case, in the event where the coordinate point (1) is the target of the iteration processing, the coordinate point stored in the web content information table is the pressed coordinate point 1001, and the candidate coordinate point is the coordinate point (1) on the web content 1005. In this case, the web content comparison unit 413 determines that the stored pressed coordinate point 1001 and the coordinate point (1) as a candidate coordinate point have the same priority level. After completing the iteration processing for all the candidate coordinate points within the defined range 1002, the replacement processing by the coordinate replacement unit 414 is not performed. In other words, the web browser 403 determines that the web content 1003 has been selected, which means that in the case shown in FIG. 10A, the user cannot get the outcome that they expect.

In FIG. 10B, the web contents 1006 and 1007 are each a web content whose HTML element is an SVG element and which measures 15 px×15 px in size. The symbols (1) and (2) each indicate the position of a candidate coordinate point, the coordinate point (1) being {690, 200} and the coordinate point (2) being {705, 200}. Also, the coordinate points (1) and (2) are targeted by the iteration processing in the order as numbered. In the example in FIG. 10B, a case is considered where the pressed coordinate point 1001 is passed to the web browser 403 as erroneous selection of the web content 1007, and the processing in FIG. 8 is executed based on the priority order table in FIG. 7.

In the above case, in the event where the coordinate point (1) is the target of the iteration processing, the coordinate point stored in the web content information table is the pressed coordinate point 1001, and the candidate coordinate point is the coordinate point (1) located on the web content 1006. In this case, the web content comparison unit 413 determines that the candidate coordinate point has a higher priority level. Then, the coordinate replacement unit 414 replaces the coordinate point stored in the web content information table and the HTML element corresponding to this coordinate point with a combination of the coordinate point (1) and the HTML element corresponding to the coordinate point (1).

In the event where the coordinate point (2) is the target of the iteration processing, because the candidate coordinate point is the coordinate point (2) located on the web content 1007, the web content comparison unit 413 determines that the stored coordinate point (1) and the coordinate point (2) as a candidate coordinate point have the same priority level. After completing the iteration processing for all the candidate coordinate points within the defined range 1002, the web browser 403 determines that the web content 1006 has been selected, which means that in the case shown in FIG. 10B, the user cannot get the outcome that they expect.

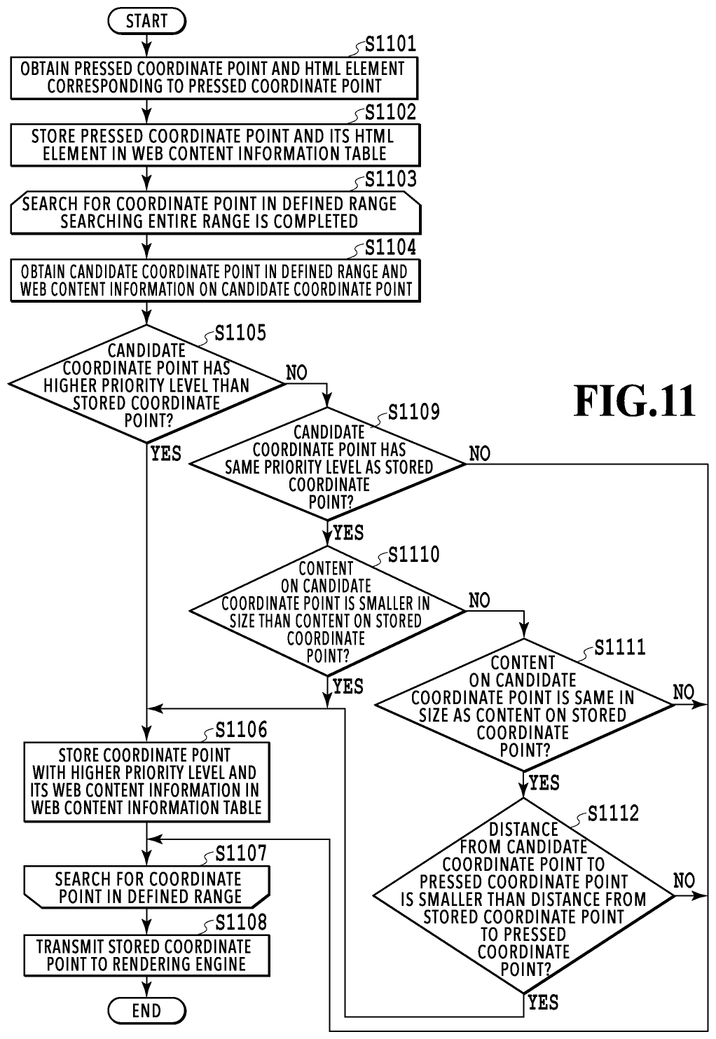

FIG. 11 is a flowchart showing an example of coordinate replacement processing executed by the MFP 110 in the present embodiment. Note that processing steps performed in S1103, S1105, S1107, and S1108 shown in FIG. 11 are the same as the processing steps performed in S803, S805, S807, and S808 shown in FIG. 8, respectively.

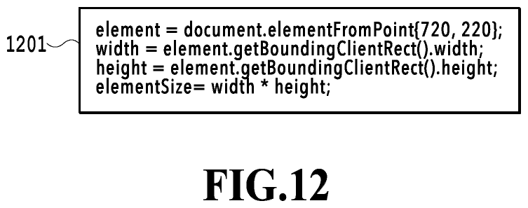

In S1101, using the pressed coordinate point storage unit 411, the CPU 201 obtains a pressed coordinate point from the window management unit 402. It is assumed here that a web content is disposed at a position overlapping with the pressed coordinate point. Using the pressed coordinate point storage unit 411, the CPU 201 obtains, based on the coordinate information obtained, the HTML element of the web content disposed at a position overlapping with the pressed coordinate point, the size of the web content, and its distance to the pressed coordinate point (hereinafter referred to as web content information). FIG. 12 is a diagram showing an example of a means for obtaining the size of a web content disposed at a position overlapping with the pressed coordinate point. The size of a web content can be obtained using JavaScript or the like. For example, based on a description 1201, the pressed coordinate point storage unit 411 can obtain the size of a web content disposed at a position overlapping with the designated coordinate point {720, 220}.

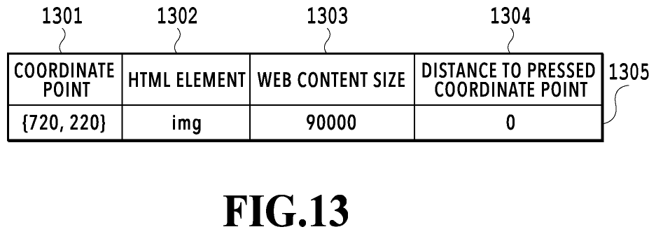

In S1102, using the pressed coordinate point storage unit 411, the CPU 201 stores the pressed coordinate point and the web content information on the pressed coordinate point into the web content information table. FIG. 13 is a diagram showing an example of the web content information table that the pressed coordinate point and its web content information are stored. A coordinate point 1301 and an HTML element 1302 correspond to the coordinate point 501 and the HTML element 502 in FIG. 5, respectively. A web content size 1303 indicates the size of the web content disposed at a position overlapping with the coordinate point 1301. A distance to the pressed coordinate point 1304 indicates a value indicating the distance from the coordinate point 1301 to the pressed coordinate point. A row 1305 indicates web content information on the pressed coordinate point 1001 stored. The row 1305 shown in FIG. 13 indicates that the HTML element of the web content disposed at a position overlapping with the coordinate point {720, 220} is an IMG element, that the size of the web content is 90000 px, and that the distance to the pressed coordinate point is 0 (zero). Note that the processing in S1103 is the same as the processing in S803 and is therefore not described here.

Referring back to FIG. 11, in S1104, using the candidate coordinate point obtainment unit 412, the CPU 201 obtains a candidate coordinate point in the current iteration processing and web content information on this candidate coordinate point.

A description is now given of how to obtain a value indicating the distance from a candidate coordinate point to a pressed coordinate point, which is included in the web content information. Based on the pressed coordinate point obtained by the pressed coordinate point storage unit 411 in S1101 and the candidate coordinate point in the current iteration processing obtained, the candidate coordinate point obtainment unit 412 obtains the distance from the candidate coordinate point to the pressed coordinate point. For example, the candidate coordinate point obtainment unit 412 obtains the pressed coordinate point {720, 200} from the pressed coordinate point storage unit 411 and obtains the candidate coordinate point {710, 190} in the current iteration processing. The candidate coordinate point obtainment unit 412 obtains the following value as distance information: (the absolute value of 710-720)+(the absolute value of 190-200), i.e., 20 px. Note that the method for obtaining a value indicating the distance from a candidate coordinate point to a pressed coordinate point is not limited to this. Any calculation method and obtainment method can be used as long as it can be used to obtain a value indicative of distance based on coordinate points.

In S1105, using the web content comparison unit 413, the CPU 201 compares the priority level of the HTML element stored and the priority level of the HTML element corresponding to the candidate coordinate point, based on the preset priority order table shown in FIG. 7. The CPU 201 proceeds to processing in S1106 if it is determined, based on the result of the comparison between the priority levels of their HTML elements, that the priority level of the candidate coordinate point is higher than that of the coordinate point stored (YES). Meanwhile, the CPU 201 proceeds to processing in S1109 if it is determined that the priority level of the candidate coordinate point is lower than or the same as that of the coordinate point stored (NO).

In S1106, using the coordinate replacement unit 414, the CPU 201 replaces the combination of the stored coordinate point and the web content information on the coordinate point with the combination of the candidate coordinate point determined as having a higher priority level and web content information on this candidate coordinate point.

In S1109, using the web content comparison unit 413, the CPU 201 determines the necessity of comparison under a different condition. Specifically, the CPU 201 determines whether the priority level of the candidate coordinate and the priority level of the stored coordinate point are the same. Here, in a case where the processing shown in FIG. 8 is performed as described earlier in the cases shown in FIGS. 10A and 10B, the user may not be able to get the outcome that they expect if the priority level of the candidate coordinate point and the priority level of the stored coordinate point are the same. Thus, in this case, the web content comparison unit 413 determines that it is necessary to make a comparison under a different condition so that a web content intended by the user may be determined as a selection target, and executes the processing in and after S1110. In S1109, the CPU 201 proceeds to processing in S1110 if it is determined that the priority level of the candidate coordinate point is the same as the priority level of the stored coordinate point (YES) and proceeds to processing in S1107 if it is determined that the priority level of the candidate coordinate point is lower than the priority level of the stored coordinate point (NO).

In S1110, using the web content comparison unit 413, the CPU 201 compares the size of the web content on the coordinate point stored in the web content information table with the size of the web content disposed at a position overlapping with the candidate coordinate point. The CPU 201 proceeds to processing in S1106 if it is determined that the size of the web content disposed at a position overlapping with the candidate coordinate point is smaller than the size of the web content on the coordinate point stored (YES). Meanwhile, the CPU 201 proceeds to processing in S1111 if it is determined that the size of the web content disposed at a position overlapping with the candidate coordinate point is larger than or the same as the size of the web content on the stored coordinate point (NO).

In S1111, using the web content comparison unit 413, the CPU 201 determines the necessity of a comparison under a different condition. Specifically, the CPU 201 determines whether the size of the web content disposed at a position overlapping with the candidate coordinate point is the same as the size of the web content on the stored coordinate point.

A case is considered here where in the case shown in FIG. 10B, the coordinate point (2) is targeted as a candidate coordinate point by the iteration processing with the coordinate point (1) and the HTML element of the web content 1006 on the coordinate point (1) being stored in the web content information table. The web content 1006 on the coordinate point (1) stored and the web content 1007 disposed at a position overlapping with the coordinate point (2) have the same priority level and size. Thus, using the priority levels and sizes of the web contents as conditions may fail to offer the outcome expected by the user. Thus, in this case, the web content comparison unit 413 determines that a comparison under a different condition is necessary in order for the web content intended by the user to be determined as a selection target, and executes processing in and after S1112.

The CPU 201 proceeds to processing in S1112 if it is determined that the size of the web content disposed at a position overlapping with the candidate coordinate point and the size of the web content on the coordinate point stored are the same (YES). The CPU 201 proceeds to processing in S1107 if it is determined that the size of the web content disposed at a position overlapping with the candidate coordinate is larger than the size of the web content on the coordinate point stored (NO).

In S1112, using the web content comparison unit 413, the CPU 201 compares a value indicating the distance from the candidate coordinate point to the pressed coordinate point and a value indicating the distance from the stored coordinate point to the pressed coordinate point. The CPU 201 proceeds to processing in S1106 if it is determined that the value indicating the distance from the candidate coordinate point to the pressed coordinate point is smaller than the value indicating the distance from the stored coordinate point to the pressed coordinate point (YES). Meanwhile, the CPU 201 proceeds to processing in S1107 if it is determined that the value indicating the distance from the candidate coordinate point to the pressed coordinate point is larger than or the same as the value indicating the distance from the stored coordinate point to the pressed coordinate point (NO).

With reference to FIGS. 10A and 10B, the processing shown in FIG. 11 is described in detail. First, in FIG. 10A, a case is considered where the pressed coordinate point 1001 is passed from the window management unit 402 to the web browser 403 as erroneous selection of the web content 1005, and the processing shown in FIG. 11 is executed based on the priority order table in FIG. 7. In the event where the coordinate point (1) is the target of the iteration processing, in S1105 and S1109, the web content comparison unit 413 determines that the stored coordinate point and the candidate coordinate point have the same priority level and proceeds to processing in S1110. In this example, the size of the web content 1003 on the stored coordinate point is 90000 px, and the size of the web content 1005 disposed at a position overlapping with the candidate coordinate point is 225 px. Thus, in S1110, the web content comparison unit 413 determines that the size of the web content 1005 disposed at a position overlapping with the candidate coordinate point is smaller than the size of the web content 1003 on the stored coordinate point. In S1106, the coordinate replacement unit 414 replaces the combination of the stored coordinate point and web content information on this coordinate point with a combination of the coordinate point (1) and web content information on the coordinate point (1). After completing the iteration processing for all the candidate coordinate points within the defined range 1002, it is determined that the web content 1005 has been selected, which means that the user can get the outcome that they expect.

Next, in FIG. 10B, a case is considered where the pressed coordinate point 1001 is passed from the window management unit 402 to the web browser 403 as erroneous selection of the web content 1007, and the processing shown in FIG. 11 is executed based on the priority order table in FIG. 7. In the event where the coordinate point (1) is the target of the iteration processing, in S1105, the web content comparison unit 413 determines that the candidate coordinate point has a higher priority level. In S1106, the coordinate replacement unit 414 replaces the combination of the stored coordinate point and web content information on this coordinate point with a combination of the coordinate point (1) and web content information on the coordinate point (1).

In the event where the coordinate point (2) is the target of the iteration processing, in S1105 and S1109, the web content comparison unit 413 determines that the coordinate point stored and the candidate coordinate point have the same priority level and proceeds to processing in S1110. In S1110, the web content comparison unit 413 determines that the size of the web content on the stored coordinate point and the size of the web content disposed at a position overlapping with the candidate coordinate point are the same and proceeds to processing in S1111. It is assumed here that the candidate coordinate point obtainment unit 412 obtains 50 px as a value indicating the distance from the stored coordinate point to the pressed coordinate point and 35 px as a value indicating the distance from the candidate coordinate point to the pressed coordinate point. In S1111, the web content comparison unit 413 determines that the value indicating the distance from the candidate coordinate point to the pressed coordinate point is smaller than the value indicating the distance from the stored coordinate point to the pressed coordinate point. In S1106, the coordinate replacement unit 414 replaces the combination of the stored coordinate point (1) and the web content information on the coordinate point (1) with a combination of the coordinate point (2) and web content information on the coordinate point (2). After completing the iteration processing for all candidate coordinate points within the defined range 1002, it is determined that the web content 1007 has been selected, which means that the user can get the outcome that they expect.

The present embodiment enables a web content expected by a user to be selected more properly by adding conditions other than the priority levels of the HTML elements.

### Third Embodiment

The present embodiment describes processing of changing the defined range used by the candidate coordinate point obtainment unit 412 and the priority order of HTML elements, so that a user can get the outcome that they expect from a web content selection operation. Note that the following description focuses on differences from the first embodiment and may omit descriptions of similar configurations.

An example is described here where a user cannot get the outcome that they expect from a web content selection operation in a case where a defined range is fixed. For example, conceivably, the size of the range to be complemented using the defined range may be different for each user or situation. In order to complement the displacement between the pressed position expected by the user and the pressed position detected by the touch processing unit 401, it is desirable that a defined range be set based on the resolution of the operation unit 111 so that the defined range may be approximately a range covered by the finger of a user upon pressing. However, for a user with a small body build, a user who touches the screen not so strongly upon pressing, or the like, the defined range may be larger than the part covered by the finger, which may result in selection of a web content not expected by the user.

Also, an example is described here where a user cannot get the outcome that they expect from a web content selection operation in a case where the priority order of HTML elements is fixed. For example, conceivably, a user may use a plurality of web apps. For example, costs in the priority order table are set based on the components of the web apps, such as lowering the cost of the target web content, so that a web content expected by a user may be prioritized. However, a user may move from a web app used for inputting to a web app used for image viewing, and these web apps from which and to which the user moves may differ in their purposes and how they use HTML elements. In this case, with a fixed priority order of HTML elements, a priority order table may be improper, and a web content not expected by a user may be selected.

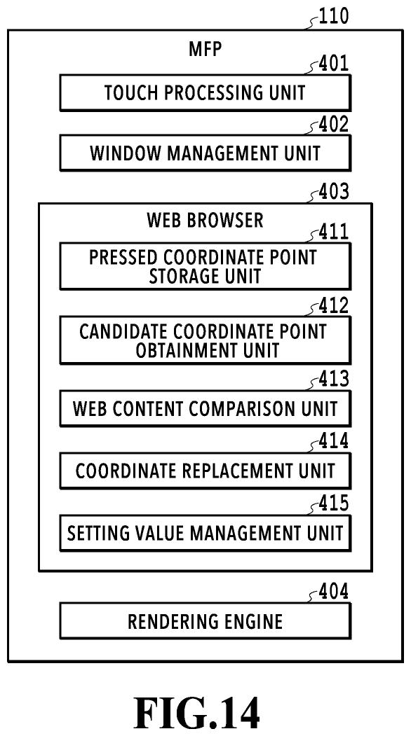

FIG. 14 is a diagram showing an example configuration of software modules in the MFP 110 according to the embodiment. The web browser 403 according to the present embodiment includes a set value management unit 415 in addition to the pressed coordinate point storage unit 411, the candidate coordinate point obtainment unit 412, the web content comparison unit 413, and the coordinate replacement unit 414. The set value management unit 415 manages the defined range used by the candidate coordinate point obtainment unit 412, a table for managing combinations of a web app and a priority order table associated with the web app, and set values of the priority order of HTML elements for each web app. The table managing combinations of a web app and a priority order table associated with the web app is hereinafter referred to as a web app table. Details of the set values managed by the set value management unit 415 will be described later.

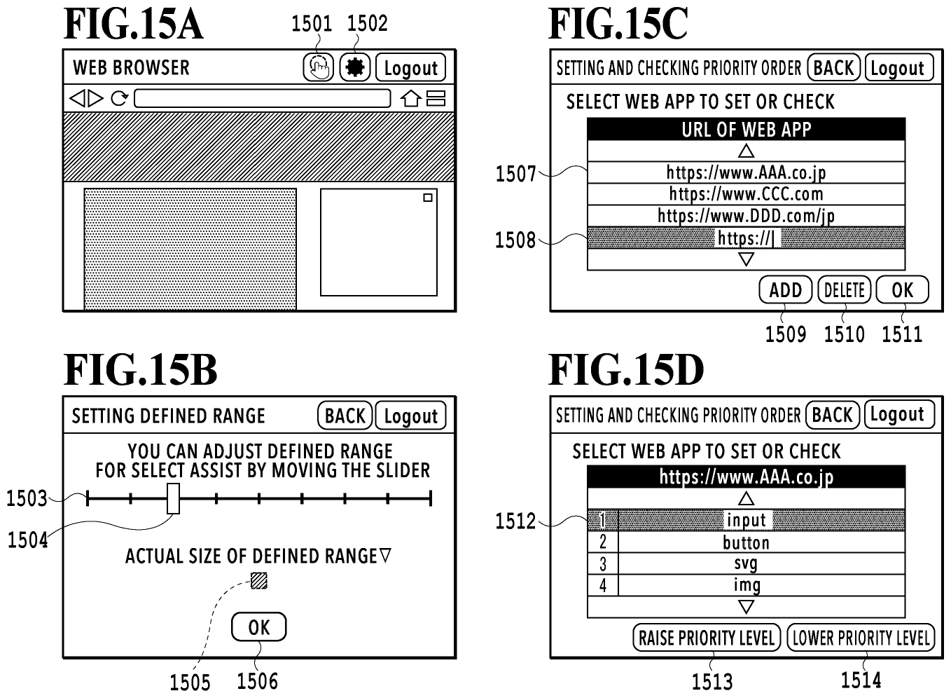

FIGS. 15A to 15D are diagrams showing an example of a display screen displayed on the operation unit 111 in the present embodiment. FIG. 15A is a diagram showing a display screen showing a web app displayed by the web browser 403. A switch button 1501 is a button for enabling or disabling the processing shown in FIG. 8 or FIG. 11, i.e., the coordinate replacement function. The coordinate replacement function is disabled in the initial state, and is enabled once the switch button 1501 is pressed with the function being disabled. Pressing the switch button 1501 with the coordinate replacement function being enabled disables the function. In a state where the coordinate replacement function is disabled, the pressed coordinate point is passed from the web browser 403 to the rendering engine 404 as is. A setting button 1502 is a button for making settings related to the web browser 403. Upon pressing of the setting button 1502, or after transitioning to several hierarchical screens after the setting button 1502 is pressed, the screen transitions to a screen like the one in FIG. 15B or 15C.

FIG. 15B is a diagram showing a screen for setting a defined range. A range scale 1503 is a straight line with scales visually representing the lower limit to the upper limit of the setting value of a defined range. A handle 1504 visually represents the currently selected setting value of the defined range and can be moved on the range scale 1503 by a user operation. A range 1505 is a graphic showing what an actual defined range looks like in a case where the currently selected setting value is applied. An OK button 1506 is a button for confirming the currently selected setting value of the defined range. Once a user moves the handle 1504 within the range of the range scale 1503 and then presses the OK button 1506, the set value management unit 415 can change the setting value of the defined range. The user can set a proper defined range by referring to the range 1505.

FIG. 15C is a diagram showing a web app selection screen for setting the priority order of HTML elements for each app. A selection field 1507 displays a list of the URLs of web apps stored by the set value management unit 415. An input field 1508 receives input of the URL of a web app to store. An Add button 1509 is a button for storing the URL of the web app inputted in the input field 1508. The user selects the input field 1508, inputs the URL of a web app, and then presses the Add button 1509. After that, the set value management unit 415 stores, into the web app table, a combination of the inputted URL of the web app and initial values in a priority order table associated with the web app. Specifically, the set value management unit 415 stores the combination into memory such as the HDD 204. A Delete button 1510 is a button for deleting a combination stored in the web app table. The user selects one of the URLs of web apps displayed in the selection field 1507 and presses the Delete button 1510. After that, the set value management unit 415 deletes a combination in the web app table matching the selected URL of the web app from the web app table. An OK button 1511 is a button for transitioning to a screen for setting the priority order of HTML elements of the selected web app. Once the user selects one of the URLs of the web apps displayed in the selection field 1507 and presses the OK button 1511, the screen transitions to a screen for setting the priority order of the HTML elements of the selected web app, like the one shown in FIG. 15D to be described later.

FIG. 15D is a diagram showing the screen for setting the priority order of the HTML elements of the web app. A selection field 1512 displays a list of HTML elements of the web app selected on the screen in FIG. 15C. Costs indicating the priority order are displayed on the left part of the selection field 1512 in ascending order of cost. HTML elements corresponding to the costs are also displayed in the selection field 1512. An Up button 1513 and a Down button 1514 are buttons for changing the priority rank of the HTML element selected in the selection field 1512.

The user selects one of the HTML elements displayed in the selection field 1512 and presses the Up button 1513. Then, the set value management unit 415 interchanges the priority rank of the selected HTML element with the priority rank of the HTML element whose cost is one rank smaller (i.e., whose priority level is one rank higher) than that of the selected HTML element. Similarly, the user selects one of the HTML elements displayed in the selection field 1512 and presses the Down button 1514. Then, the set value management unit 415 interchanges the priority rank of the selected HTML element with the priority rank of the HTML element whose cost is one rank larger (i.e., whose priority level is one rank lower) than that of the selected HTML element.

By allowing a user to change the defined range and the set values for the priority order of HTML elements, the present embodiment enables the web content expected by the user to be selected more properly.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-000698, filed Jan. 5, 2024, which is hereby incorporated by reference herein in its entirety.

What is claimed is:

1. An information processing apparatus comprising:
at least one memory and at least one processor which function as:
a display control unit that performs control to display a screen including a first object and a second object different from the first object;
a first obtainment unit that obtains a pressed coordinate point which is a coordinate point on the screen where an input operation on the screen by a user is performed; and
a determination unit that makes a determination as to an object selected by the input operation by comparing a first priority level set for a type of the first object disposed within a predetermined range from the pressed coordinate point and a second priority level set for a type of the second object disposed within the predetermined range.

2. The information processing apparatus according to claim 1, wherein
the first priority level is a preset priority level corresponding to an HTML element indicating the type of the first object, and
the second priority level is a preset priority level corresponding to an HTML element indicating the type of the second object.

3. The information processing apparatus according to claim 2, wherein
the determination unit compares the first priority level and the second priority level based on a preset priority order indicating priority levels corresponding to a plurality of HTML elements.

4. The information processing apparatus according to claim 3, further comprising a control unit that performs control to change, based on a user operation, the priority levels corresponding to the plurality of HTML elements for each web application.

5. The information processing apparatus according to claim 4, wherein
the control unit further performs control to change a size of the predetermined range based on a user operation.

6. The information processing apparatus according to claim 1, wherein
in a case where the first priority level is higher than the second priority level, the determination unit determines that the first object is the object selected by the input operation.

7. The information processing apparatus according to claim 6, wherein
even in a case where the pressed coordinate point is located on the second object, the determination unit determines that the first object is the object selected by the input operation.

8. The information processing apparatus according to claim 1, wherein
in a case where the first priority level and the second priority level are same, the determination unit makes the determination based on a size of the first object and a size of the second object.

9. The information processing apparatus according to claim 8, wherein
in a case where the first object is smaller than the second object, the determination unit determines that the first object is the object selected by the input operation.

10. The information processing apparatus according to claim 1, wherein
a plurality of candidate coordinate points used for the determination made by the determination unit are located within the predetermined range, and
the information processing apparatus further comprises a second obtainment unit that, in a case where any one of the plurality of candidate coordinate points is located on any one of the first object and the second object, obtains a first candidate coordinate point located on the first object and a second candidate coordinate point located on the second object.

11. The information processing apparatus according to claim 10, wherein
in a case where a size of the first object and a size of the second object are same, the determination unit makes the determination based on a value indicating a distance from the first candidate coordinate point to the pressed coordinate point and a value indicating a distance from the second candidate coordinate point to the pressed coordinate point.

12. The information processing apparatus according to claim 11, wherein
in a case where the value indicating the distance from the first candidate coordinate point to the pressed coordinate point is smaller than the value indicating the distance from the second candidate coordinate point to the pressed coordinate point, the determination unit determines that the first object is the object selected by the input operation.

13. The information processing apparatus according to claim 1, wherein
the information processing apparatus is an image formation apparatus.

14. An information processing apparatus having a display, the information processing apparatus comprising:
at least one memory and at least one processor which function as:
a first obtainment unit that obtains a pressed coordinate point which is a coordinate point on a screen displayed on the display, the pressed coordinate point being where an input operation on the screen by a user is performed;
a second obtainment unit that obtains a plurality of candidate coordinate points located within a predetermined range from the pressed coordinate point;
a determination unit that makes a determination as to an object selected by the input operation by comparing a first priority level set for a type of a first object where any one of the plurality of candidate coordinate points is located and a second priority level set for a type of a second object where any one of the plurality of candidate coordinate points is located, the second object being different from the first object; and
a transmission unit that transmits coordinates of the object determined by the determination unit to a rendering engine.

15. A control method of an information processing apparatus, the control method comprising:
performing control to display a screen including a first object and a second object different from the first object;
obtaining a pressed coordinate point which is a coordinate point on the screen where an input operation on the screen by a user is performed; and
making a determination as to an object selected by the input operation by comparing a first priority level set for a type of the first object disposed within a predetermined range from the pressed coordinate point and a second priority level set for a type of the second object disposed within the predetermined range.
